(19) United States
(12) Patent Application Publication
(10) Pub. No.: US 2024/0166245 A1
(43) Pub. Date: May 23, 2024

(54) MUTUAL MONITORING OF HIGH-PERFORMANCE COMPUTING (HPC) SYSTEMS TO CONTROL VEHICLE OPERATION

(71) Applicant: FORD GLOBAL TECHNOLOGIES, LLC., Dearborn, MI (US)

(72) Inventors: Stuart LOWE, Gibsonia, PA (US); Tilmann OCHS, Munich (DE)

(73) Assignee: FORD GLOBAL TECHNOLOGIES, LLC, Dearborn, MI (US)

(21) Appl. No.: 17/993,230

(22) Filed: Nov. 23, 2022

(51) Int. Cl. B60W 60/00; B60W 50/02

(52) U.S. Cl. CPC B60W 60/0027; B60W 50/0205; B60W 2554/40

(57) ABSTRACT

A diagnostic system of a vehicle may evaluate the output of a first monitor configured to identify conflicts with forecasts for objects in proximity to the vehicle generated by a first processor based on perception information that indicates the objects to determine whether there is a conflict with a forecast for an object of the objects in proximity to the vehicle. The diagnostic system may evaluate the output of a second monitor configured to identify conflicts with instructions for controlling an operation of the vehicle generated by a second processor based on the perception information to determine whether there is a conflict with the instruction. The diagnostic system may provide instruction for causing the vehicle to execute a maneuver responsive a conflict with the forecast for the object, the conflict with the instruction for controlling the operation of the vehicle, and/or the like.

### BACKGROUND

An autonomous (e.g., self-driving, etc.) system used by vehicles typically relies on extensive compute resources for the processing of sensor data and for planning vehicle behavior. The capabilities of an autonomous system may be constrained by its compute resources. Data-center class hardware and operating systems that are not designed for being used in safety-critical systems are often implemented in autonomous systems in early development. However, data-center class hardware, commonly-used microcontrollers, and conventional operating systems may not feature safety mechanisms and documentation required by safety standards (e.g., Safety of the Intended Functionality (SOTIF) Standards, Functional Safety (FUSA) Standards, etc.). Therefore, creating a system that complies with safety standards using conventionally available hardware and operating system technologies is challenging.

Autonomous systems that implement redundant (e.g., functional redundant, hardware/structurally redundant, etc.) high-performance computing (HPC) systems (e.g., perception systems, planning systems, etc.) and/or a diagnostic system operating on an HPC processor are prone to fail due to any fault that affects the software of its HPC systems. A fault affecting the diagnostic system could potentially prevent and/or block a necessary fault reaction for a vehicle. Replicating diagnostics systems for redundant HPC systems suffers from asynchronous signals generated by autonomy software arriving in different orders at the replicated diagnostic system, thus yielding slightly different state transitions and timing in both copies of the diagnostic system. Autonomous systems with replicated diagnostics systems may not be able to distinguish this different behavior of the two copies from a fault in one of the copies by the receiver of the two output signals, and thus may not be able to trigger an adequate fault response.

### SUMMARY

A computer-based system of an autonomous vehicle (AV) may include an architecture that enables mutual monitoring of high-performance computing components and intelligent control of the AV. For example, according to some aspects of the disclosure, a first processor of a computing system for a vehicle may generate a forecast for an object in proximity to the vehicle based on perception information that indicates the object. A first component of the computing system that monitors forecast output by the first processor may identify a conflict with the forecast for the object based on the perception information. A second processor of the computing system may generate an instruction for controlling an operation of the vehicle based on the perception information, and a second component of the computing system that monitors instructions output by the second processor may identify a conflict with the instruction for controlling the operation of the vehicle based on the perception information. A third component of the computing system that evaluates output from the first component and the second component may send an instruction for causing a maneuver for the vehicle, for example, based on at least one of the identified conflict with the forecast for the object or the identified conflict with the instruction for controlling the operation of the vehicle.

### BRIEF DESCRIPTION OF THE DRAWINGS

The accompanying drawings are incorporated herein and form a part of the specification.

FIG. 1 shows an example autonomous vehicle system, according to aspects of the disclosure.

FIG. 2 shows an example architecture for a vehicle, according to aspects of the disclosure.

FIGS. 3A-3D show example architectures for mutual monitoring of high-performance computing systems to control vehicle operation, according to aspects of the disclosure.

FIG. 4 shows a flowchart of an example method for mutual monitoring of high-performance computing systems to control vehicle operation, according to aspects of the disclosure.

FIG. 5 shows a flowchart of an example method for mutual monitoring of high-performance computing systems to control vehicle operation, according to aspects of the disclosure.

FIG. 6 shows an example computer system useful for implementing various examples, aspects, and/or embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for mutual monitoring of high-performance computing (HPC) systems to control vehicle operation. As described herein, an autonomous system (e.g., self-driving system, computing system, etc.) of a vehicle may implement two independent compute systems, implemented on separate CPU boards, for example, CPU0 and CPU1. At a high level, CPU0 may be in communication with the vehicle sensor systems and may execute independent perception software for analyzing data/information from the sensor systems. According to some aspects of this disclosure, CPU0 may send data/information indicative of the environment around the vehicle to CPU1. CPU1 may execute independent planning software for analyzing data/information indicative of the environment around the vehicle and calculate trajectories for objects in proximity to the vehicle and calculates a trajectory for the vehicle which accounts for the calculated trajectories.

The autonomous system may implement monitors on both CPUs such that the monitored function for either monitor resides on a different CPU. For example, a perception monitor may be implemented on CPU1, and a planning monitor may be implemented on CPU0. Accordingly, a random hardware fault in either CPU of the autonomous system (e.g., CPU0 or CPU1) or a sporadic systematic fault in one of the operating system instances will either affect a monitor or a respective monitored function, but not both. A concurrent failure of both CPUs or operating system instances is unlikely. This approach allows for the use of hardware that is not explicitly designed for use in critical systems to meet applicable standards.

According to some aspects of this disclosure, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and/or the like. An “autonomous vehicle” (or “AV”) is a vehicle having a processor, programming instructions, and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Notably, the present solution is described herein in the context of an autonomous vehicle. However, the present solution is not limited to autonomous vehicle applications. The present solution may be used in other applications such as robotic applications, radar system applications, metric applications, and/or system performance applications.

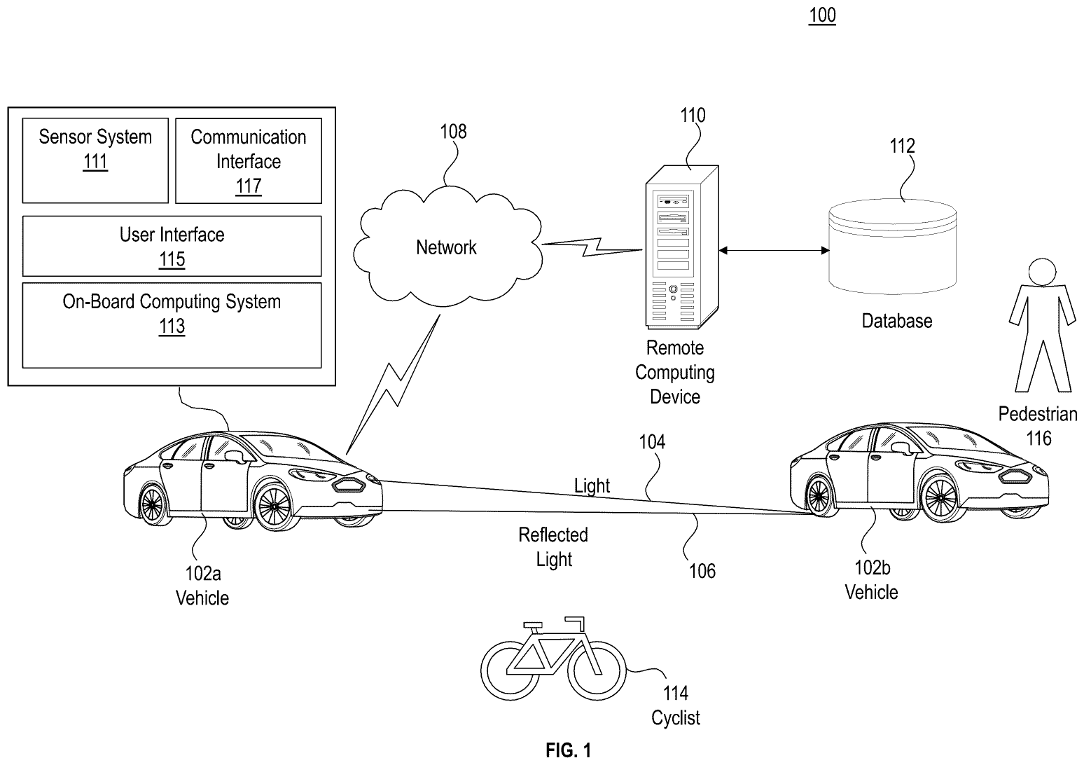

FIG. 1 shows an example autonomous vehicle system 100, according to aspects of the disclosure. System 100 comprises vehicle 102a which is traveling along a road in a semi-autonomous or autonomous manner. Vehicle 102a is also referred to herein as AV 102a. According to some aspects of this disclosure, AV 102a can include, but is not limited to, a land vehicle (as shown in FIG. 1), an aircraft, or a watercraft.

AV 102a is generally configured to detect objects 102b, 114, and 116 in proximity thereto. According to some aspects of this disclosure, the objects can include, but are not limited to, a vehicle 102b, cyclist 114 (such as a rider of a bicycle, electric scooter, motorcycle, or the like), and/or a pedestrian 116.

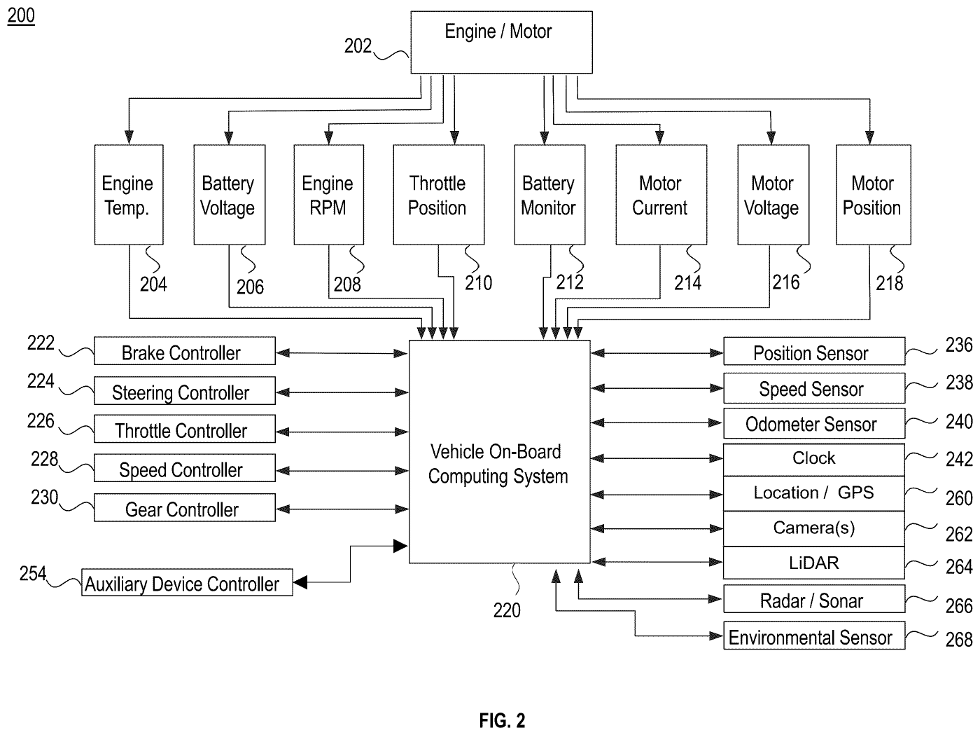

As shown in FIG. 1, according to some aspects of this disclosure, the AV 102a may include a sensor system 111, an on-board computing system 113, a communications interface 117, and a user interface 115. Autonomous vehicle 101 may further include certain components (as illustrated, for example, in FIG. 2) included in vehicles, which may be controlled by the on-board computing system 113 using a variety of communication signals and/or commands, such as, for example, acceleration signals or commands, deceleration signals or commands, steering signals or commands, braking signals or commands, etc.

According to some aspects of this disclosure, the sensor system 111 may include one or more sensors that are coupled to and/or are included within the AV 102a, as illustrated in FIG. 2. For example, such sensors may include, without limitation, a lidar system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., a global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the AV 102a, information about the environment itself, information about the motion of the AV 102a, information about a route of the vehicle, or the like. As AV 102a travels over a surface, at least some of the sensors may collect data pertaining to the surface.

According to some aspects of this disclosure, AV 102a may be configured with a lidar system, e.g., lidar system 264 of FIG. 2. The lidar system may be configured to transmit a light pulse 104 to detect objects located within a distance or range of distances of AV 102a. Light pulse 104 may be incident on one or more objects (e.g., AV 102b) and be reflected back to the lidar system. Reflected light pulse 106 incident on the lidar system may be processed to determine a distance of that object to AV 102a. The reflected light pulse may be detected using, in some embodiments, a photodetector or array of photodetectors positioned and configured to receive the light reflected back into the lidar system. Lidar information, such as detected object data, is communicated from the lidar system to an on-board computing device, e.g., on-board computing system 220 of FIG. 2. (e.g., on-board computing system 113 of FIG. 1). The AV 102a may also communicate lidar data to a remote computing device 110 (e.g., cloud processing system) over communications network 108. Remote computing device 110 may be configured with one or more servers to process one or more processes of the technology described herein. Remote computing device 110 may also be configured to communicate data/instructions to/from AV 102a over network 108, to/from server(s) and/or database(s) 112.

It should be noted that the lidar systems for collecting data pertaining to the surface may be included in systems other than the AV 102a such as, without limitation, other vehicles (autonomous or driven), robots, satellites, etc.

Network 108 may include one or more wired or wireless networks. For example, the network 108 may include a cellular network (e.g., a long-term evolution (LTE) network, a code division multiple access (CDMA) network, a 3G network, a 4G network, a 5G network, another type of next-generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102a may retrieve, receive, display, and edit information generated from a local application or delivered via network 108 from database 112. Database 112 may be configured to store and supply raw data, indexed data, structured data, map data, program instructions, and/or any type of data/information.

The communications interface 117 may be configured to allow communication between AV 102a and external systems, for example, external devices, sensors, other vehicles, servers, data stores, databases, etc. The communications interface 117 may utilize any now or hereafter-known protocols, protection schemes, encodings, formats, packaging, etc. such as, without limitation, Wi-Fi, an infrared link, Bluetooth, etc. The user interface 115 may be part of peripheral devices implemented within the AV 102a including, for example, a keyboard, a touch screen display device, a microphone, a speaker, etc.

FIG. 2 shows an example system architecture 200 for a vehicle, according to aspects of the disclosure. According to some aspects of this disclosure, vehicles 102a and/or 102b of FIG. 1 can have the same or similar system architecture as that shown in FIG. 2. Thus, the following discussion of system architecture 200 is sufficient for understanding vehicle(s) 102a, 102b of FIG. 1. However, other types of vehicles are considered within the scope of the technology described herein and may contain more or fewer elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors, and controllers may be included based on a type of vehicle, as is known.

As shown in FIG. 2, system architecture 200 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations Per Minute (“RPM”) sensor 208, and a throttle position sensor 210. If the vehicle is an electric vehicle and/or a hybrid vehicle, then the vehicle may have an electric motor, and accordingly includes sensors such as a battery monitoring system 212 (to measure current, voltage, and/or temperature of the battery), motor current 214 and voltage 216 sensors, and motor position sensors 218 such as resolvers and encoders.

Operational parameter sensors that are common to both types of vehicles include, for example: a position sensor 236 such as an accelerometer, gyroscope, and/or inertial measurement unit; a speed sensor 238; and an odometer sensor 240. The vehicle also may have a clock 242 that the system uses to determine vehicle time during operation. The clock 242 may be encoded into the vehicle on-board computing device, it may be a separate device, or multiple clocks may be available.

According to some aspects of this disclosure, the vehicle also includes various sensors that operate to gather information about the environment in which the vehicle is traveling. These sensors may include, for example: a location sensor 260 (e.g., a Global Positioning System (“GPS”) device); object detection sensors such as one or more cameras 262; a lidar system 264; and/or a radar and/or a sonar system 266. The sensors also may include environmental sensors 268 such as a precipitation sensor and/or ambient temperature sensor. The object detection sensors may enable the vehicle to detect objects that are within a given distance range of the vehicle 200 in any direction, while the environmental sensors collect data about environmental conditions within the vehicle's area of travel.

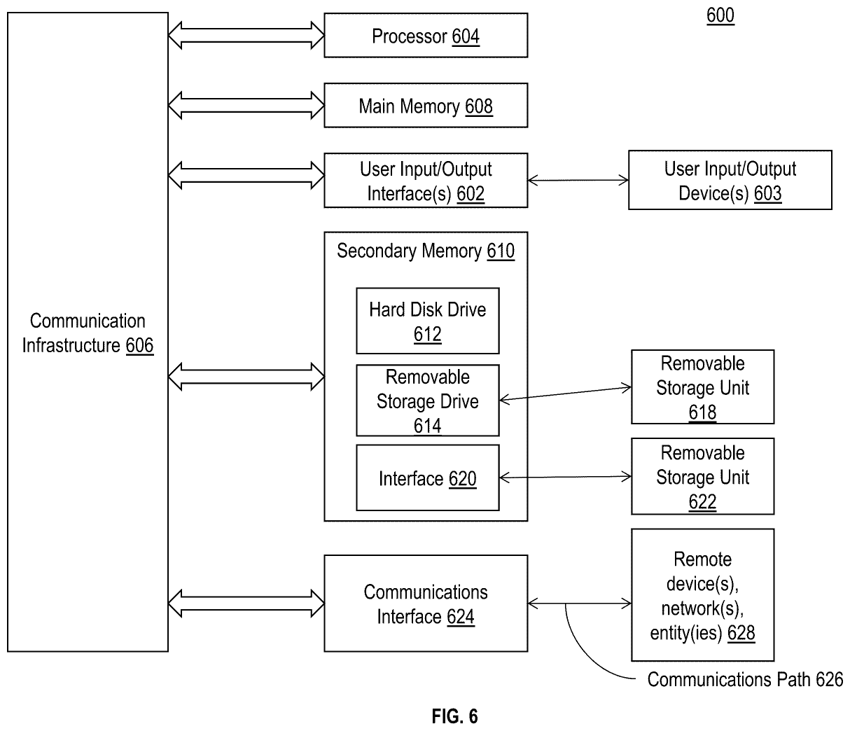

During operations, information is communicated from the sensors to a vehicle on-board computing system 220. The on-board computing system 220 may be implemented using the computer system of FIG. 6. The vehicle on-board computing system 220 analyzes the data captured by the sensors and optionally controls operations of the vehicle based on results of the analysis. For example, the vehicle on-board computing system 220 may control: braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers. Auxiliary device controller 254 may be configured to control one or more auxiliary devices, such as testing systems, auxiliary sensors, mobile devices transported by the vehicle, etc.

Geographic location information may be communicated from the location sensor 260 to the on-board computing system 220, which may then access a map of the environment that corresponds to the location information to determine known fixed features of the environment such as streets, buildings, stop signs and/or stop/go signals. Captured images from the cameras 262 and/or object detection information captured from sensors such as lidar system 264 is communicated from those sensors) to the on-board computing system 220. The object detection information and/or captured images are processed by the on-board computing system 220 to detect objects in proximity to the vehicle 200. Any known or to be known technique for making an object detection based on sensor data and/or captured images can be used in the embodiments disclosed in this document.

Lidar information is communicated from lidar system 264 to the on-board computing system 220. Additionally, captured images are communicated from the camera(s) 262 to the vehicle on-board computing system 220. The lidar information and/or captured images are processed by the vehicle on-board computing system 220 to detect objects in proximity to the vehicle 200. The manner in which the object detections are made by the vehicle on-board computing system 220 includes such capabilities detailed in this disclosure.

The on-board computing system 220 may include and/or may be in communication with a planning system that generates a navigation route from a start position to a destination position for an autonomous vehicle. The planning system may access a map data store to identify possible routes and road segments that a vehicle can travel on to get from the start position to the destination position. The planning system may score the possible routes and identify a preferred route to reach the destination. For example, the planning system may generate a navigation route that minimizes Euclidean distance traveled or other cost functions during the route, and may further access the traffic information and/or estimates that can affect the amount of time it will take to travel on the particular route. Depending on the implementation, the planning system may generate one or more routes using various routing methods, such as Dijkstra's algorithm, Bellman-Ford algorithm, or other algorithms. The planning system may also use the traffic information to generate a navigation route that reflects expected conditions of the route (e.g., the current day of the week, the current time of day, etc.), such that a route generated for travel during rush hour may differ from a route generated for travel late at night. The planning system may also generate more than one navigation route to a destination and send more than one of these navigation routes to a user for selection by the user from among various possible routes.

According to some aspects of this disclosure, the on-board computing system 220 may include a perception system to determine perception information of the surrounding environment of the AV 102a. Based on the sensor data provided by one or more sensors and location information that is obtained, the perception system may determine perception information indicative of the surrounding environment of the AV 102a. The perception information may represent what an ordinary driver would perceive in the surrounding environment of a vehicle. The perception data may include information relating to one or more objects in the environment of the AV 102a. For example, the perception system may process sensor data (e.g., lidar or RADAR data, camera images, etc.) in order to identify objects and/or features in the environment of AV 102a. The objects may include traffic signals, roadway boundaries, other vehicles, pedestrians, and/or obstacles, etc. The perception system may use any now or hereafter-known object recognition algorithms, video tracking algorithms, and computer vision algorithms (e.g., track objects frame-to-frame iteratively over a number of time periods) to determine the perception.

According to some aspects of this disclosure, the on-board computing system 220 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

According to some aspects of this disclosure, the on-board computing system 220 may perform one or more prediction and/or forecasting operations. For example, the on-board computing system 220 (e.g., the planning system, etc.) may predict future locations, trajectories, and/or actions of one or more objects. For example, the on-board computing system 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the AV 102a, the surrounding environment, and/or their relationship(s). For example, if an object is a vehicle and the current driving environment includes an intersection, the on-board computing system 220 may predict whether the object will likely move straight forward or make a turn. If the perception data indicates that the intersection has no traffic light, the on-board computing system 220 may also predict whether the vehicle may have to fully stop prior to enter the intersection.

According to some aspects of this disclosure, the on-board computing system 220 (e.g., the planning system, etc.) may determine a motion plan for the autonomous vehicle. For example, the on-board computing system 220 may determine a motion plan for the autonomous vehicle based on the perception data and/or the prediction data. Specifically, given predictions about the future locations of proximate objects and other perception data, the on-board computing system 220 can determine a motion plan for the AV 102a that best navigates the autonomous vehicle relative to the objects at their future locations.

According to some aspects of this disclosure, the on-board computing system 220 may receive predictions and make a decision regarding how to handle objects and/or actors in the environment of the AV 102a. For example, for a particular actor (e.g., a vehicle with a given speed, direction, turning angle, etc.), the on-board computing system 220 decides whether to overtake, yield, stop, and/or pass based on, for example, traffic conditions, map data, state of the autonomous vehicle, etc. Furthermore, the on-board computing system 220 also plans a path for the AV 102a to travel on a given route, as well as driving parameters (e.g., distance, speed, and/or turning angle). That is, for a given object, the on-board computing system 220 decides what to do with the object and determines how to do it. For example, for a given object, the on-board computing system 220 may decide to pass the object and may determine whether to pass on the left side or right side of the object (including motion parameters such as speed). The on-board computing system 220 may also assess the risk of a collision between a detected object and the AV 102a. If the risk (e.g., level of criticality, etc.) exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing system 220 may execute one or more control instructions to perform a cautious maneuver (e.g., mildly slow down, accelerate, change lane, or swerve). In contrast, if the collision cannot be avoided, then the on-board computing system 220 may execute one or more control instructions for execution of an emergency maneuver (e.g., brake and/or change direction of travel).

As discussed above, planning and control data regarding the movement of the autonomous vehicle is generated for execution. The on-board computing system 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

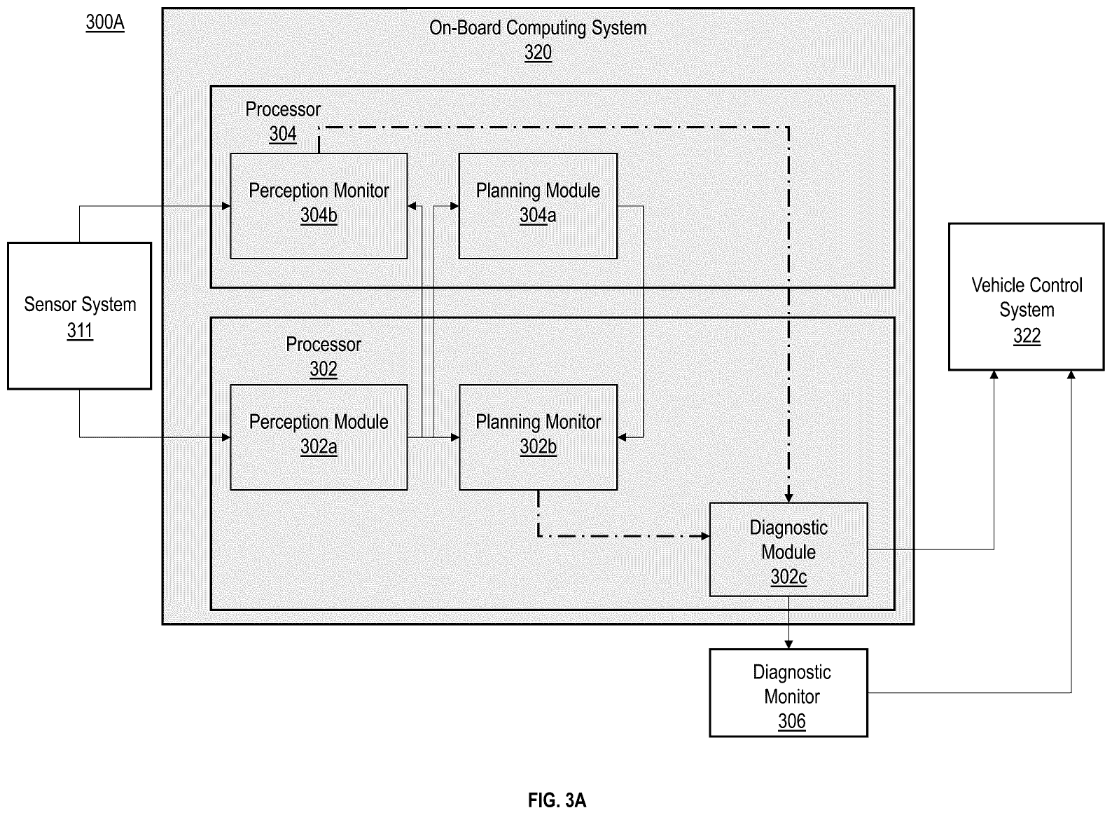

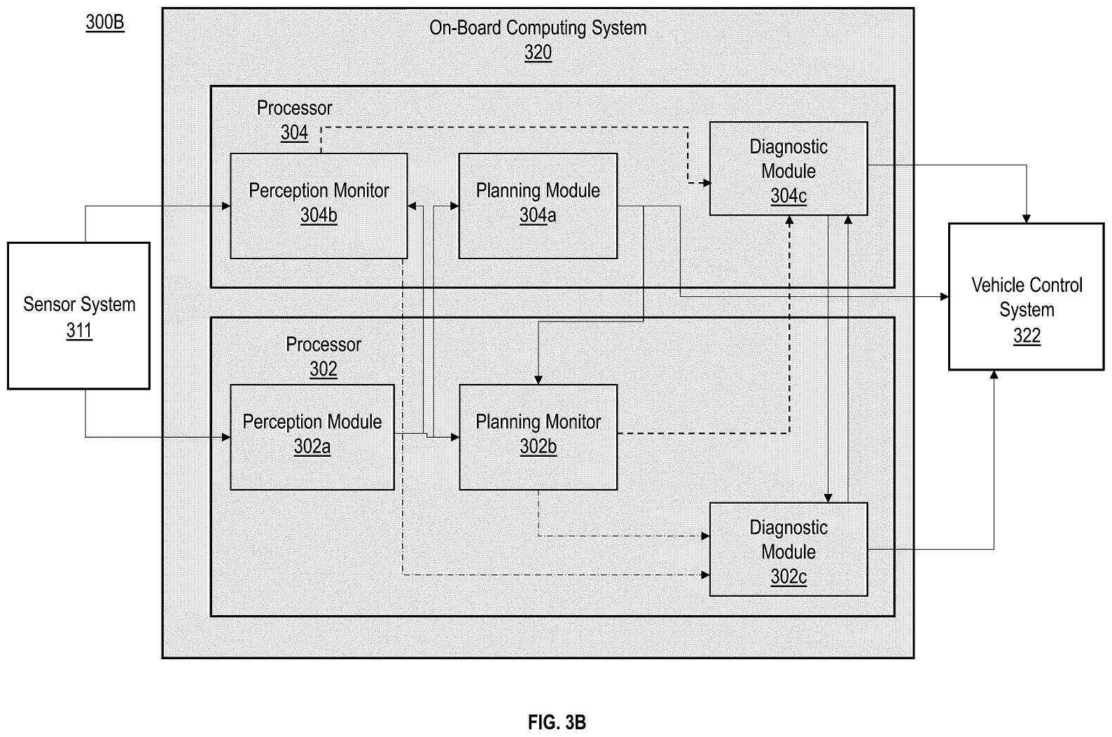

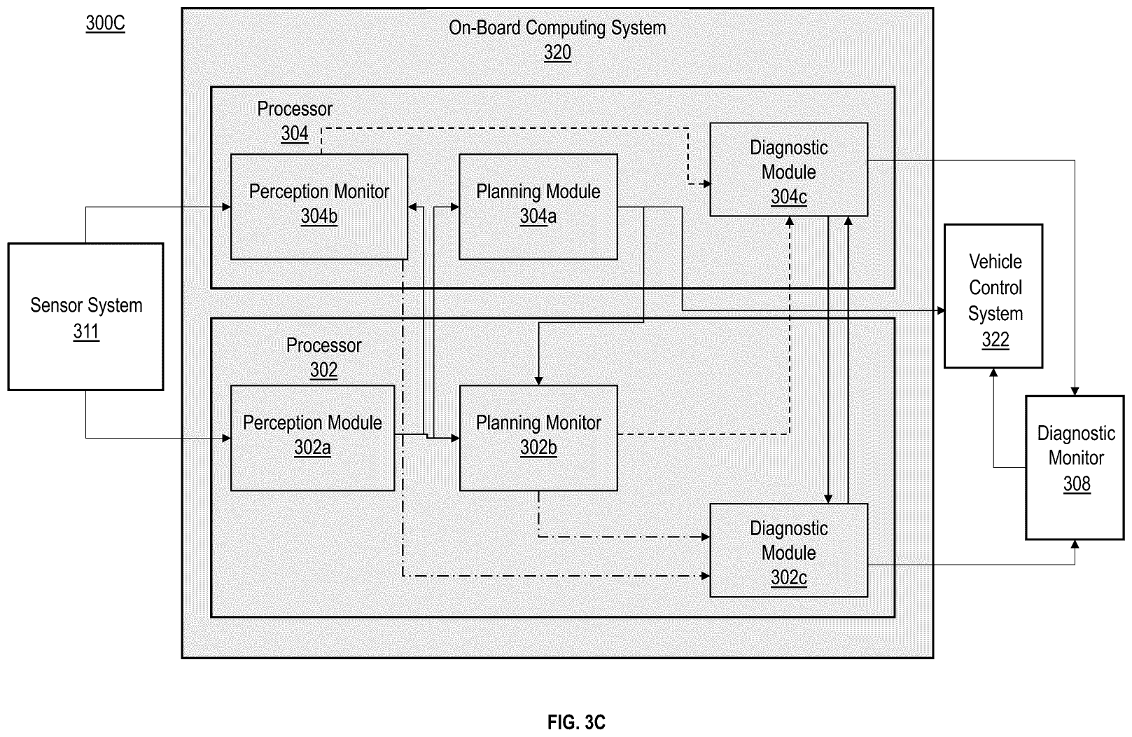

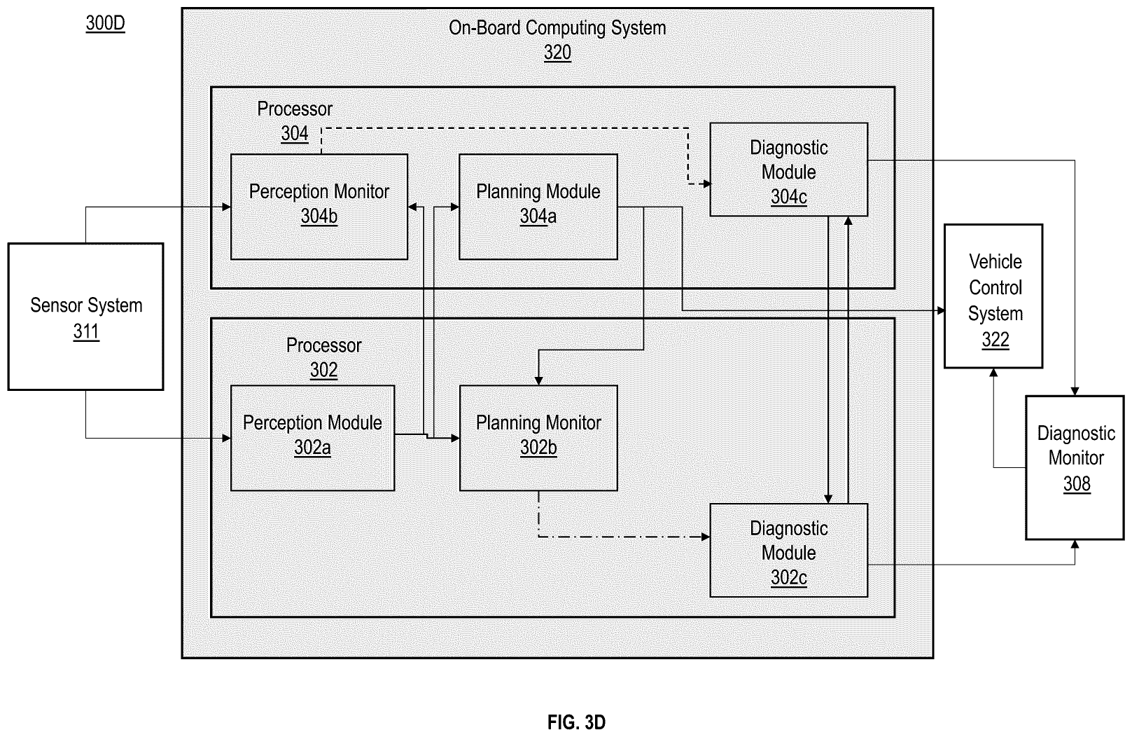

FIGS. 3A-3D show example architectures for mutual monitoring of high-performance computing systems to control vehicle operation, according to aspects of this disclosure. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIGS. 3A-3D, as will be understood by a person of ordinary skill in the art.

According to some aspects of this disclosure, the example of architectures that are shown in FIGS. 3A-3D foresees the monitoring of the diagnostics system of a vehicle system by implementing diagnostics monitors. According to some aspects of this disclosure, function monitors may reside on different CPUs, monitor the perception and planning functions of an autonomous system, and report any detected errors to the diagnostics system to trigger a fault response. Some mechanisms, such as checksums and timing supervision for the diagnostics communication (e.g., periodic heartbeats, etc.) are implemented to identify any malfunction of the diagnostics system and trigger a vehicle maneuver.

According to some aspects of this disclosure, the example of architectures that are shown in FIGS. 3A-3D may be implemented with data-center class hardware, each operating with independent task/function-specific software, to avoid complete system failures caused by software-related issues. According to some aspects of this disclosure, the example of architectures that are shown in FIGS. 3A-3D each comply with various standards.

An autonomous (e.g., self-driving, etc.) system used by vehicles typically relies on extensive compute resources for the processing of sensor data and planning vehicle behavior. According to some aspects of this disclosure, the example of architectures shown in FIGS. 3A-3D each enable and/or facilitate significantly more compute resources to be provided to intended functions (e.g., processing of sensor data, planning vehicle behavior, etc.) than typical autonomous (e.g., self-driving, etc.) systems. For example, as described in greater detail herein, the function (e.g., perception, planning, etc.) monitors implemented in the example on-board computing systems require significantly fewer compute resources than the components/elements responsible for the functions they monitor, and the maximal available compute resources per hardware component/element is supported by what datacenter class components/elements provide. While, typical autonomous (e.g., self-driving, etc.) systems waste significant portions of their compute resources that could be used to monitor their system functions, the example of architectures shown in FIGS. 3A-3D are each configured to maximize and/or utilize their available compute resources. Accordingly, the example of architectures shown in FIGS. 3A-3D each provide appropriate operation of an AV. In other words, the example of architectures shown in FIGS. 3A-3D are each configured to provide the highest possible amount of computing resources with given data center technology (e.g., utilizing data center-class devices/components, etc.) to any intended function (e.g., perception, planning, etc.), which maximizes the effectiveness of the intended function—a crucial aspect for AV systems. These and other technological advantages are described herein.

As shown in FIGS. 3A-3D, example system architectures 300A-300D can have similar system architectures as example system architecture 200 shown in FIG. 2. Thus, any previous discussion of the system architecture 200 is applicable for understanding example system architectures 300A-300D. For example, according to some aspects of this disclosure, system architectures 300A-300D may include on-board computing system 320. According to some aspects of this disclosure, on-board computing system 320 may perform any function/operation described for on-board computing system 220 of FIG. 2 (and/or on-board computing system 113 of FIG. 1, etc.). According to some aspects of this disclosure, architectures 300A-300D may include sensor system 311. According to some aspects of this disclosure, sensor system 311 may perform any function/operation described for sensor system 111 of FIG. 1 (and/or location sensor 260, cameras 262, lidar system 264, radar and/or a sonar system 266, environmental sensors 268, etc. of FIG. 2, etc.). According to some aspects of this disclosure, architectures 300A-300D may include a vehicle control system 322. According to some aspects of this disclosure, vehicle control system 322 may perform any function/operation described for any of the controller components 222-230 and 254 of FIG. 2. Example system architectures 300A-300D further include their own distinguishing features. According to some aspects of this disclosure, on-board computing system 320 of system architectures 300A-300D may include HPC components that meet any automotive risk classification requirements and/or standards (e.g., ISO 26262, etc.) including, but not limited to, ASIL-D requirements and/or the like.

FIG. 3A shows an example system architecture 300A which includes on-board computing system 320. According to some aspects of this disclosure, on-board computing system 320 may include data-center class compute systems, implemented on separate processors/CPUs. For example, on-board computing system 320 may include a processor 302 and a processor 304. According to some aspects of this disclosure, processor 302 and processor 304 may each be in communication with sensor system 311 and may execute independent software for analyzing data/information (e.g., perception information, etc.) from sensor system 311.

According to some aspects of this disclosure, processor 302, processor 304, sensor system 311, diagnostic monitor 306, and/or vehicle control system 322 of system architecture 300A may be in communication via dedicated high-speed communication channels, such as Ethernet channels and/or the like, configured to transfer collected data from high data rate devices (e.g., lidar, radar, etc.) capable of sampling millions of data points per second. According to some aspects of this disclosure, a CAN-FD (Controller Area Network Flexible Data-Rate) connection may be implemented. CAN-FD is a data-communication protocol typically used for broadcasting sensor data and control information on 2 wire interconnections between different parts of electronic instrumentation and control systems. CAN-FD is commonly used in modern high-performance vehicles. However, any known or future high-speed data transmission channels, wired technology/technique, fiber optic communication technique, and/or wireless (e.g., 5G, 6G, Ultra-wideband, etc.) communication technology/technique may be substituted without departing from the scope of the technology described herein.

According to some aspects of this disclosure, processor 302 may include a perception module 302a that receives data/information indicative of the environment around a vehicle (e.g., AV 102a of FIG. 1, etc.) from the sensor system 311. For example, data/information indicative of the environment around a vehicle may include, but is not limited to, objects in proximity to the vehicle. According to some aspects of this disclosure, perception module 302a may execute independent planning software for analyzing data/information indicative of the environment around a vehicle and performing point cloud processing, object detection and identification, and/or any other perception-related functions. According to some aspects of this disclosure, perception module 302a may execute any complex and/or perception-related function and/or task associated with data/information received from sensor system 311 and/or the like. For example, according to some aspects of this disclosure, perception module 302a may generate a forecast for the identification of an object (e.g., a person, an animal, a vehicle, a roadway, a traffic sign, an inanimate object, etc.) detected in proximity to a vehicle.

According to some aspects of this disclosure, perception module 302a may send data/information indicative of the environment around a vehicle to a planning module 304a of processor 304. The planning module 304a may execute independent planning software for analyzing data/information indicative of the environment around a vehicle and calculating trajectories for objects in proximity to the vehicle. According to some aspects of this disclosure, planning module 304a may calculate a trajectory for a vehicle which accounts for calculated trajectories for objects in proximity to the vehicle. According to some aspects of this disclosure, planning module 304a may generate an instruction (e.g., a motion path/plan, etc.) for controlling an operation (e.g., motion, movement, etc.) of the vehicle.

According to some aspects of this disclosure, output from planning module 304a may be sent to vehicle control system 322. Vehicle control system 322 may control operations of the vehicle-based output and/or instruction from planning module 304a. For example, vehicle control system 322 may be in communication with one or more actuators and/or controllers to control including, but not limited to, vehicle braking, direction/steering, speed, acceleration, gears/transmission, engine/motor operation, and/or the like.

According to some aspects of this disclosure, on-board computing system 320 may include domain-specific (e.g., perception system monitor, planning system monitors, operation and control monitors, system integrity monitors, etc.) monitors configured with complex software for managing compute-intensive data/information. According to some aspects of this disclosure, on-board computing system 320 may implement monitors on both processor 302 and processor 304 such that the monitored function (e.g, perception, planning, etc.) for either monitor resides on a different processor.

According to some aspects of this disclosure, processor 302 may include a planning monitor 302b that monitors output (e.g., motion planning instructions, trajectories, etc.) from the planning module 304a. Planning monitor 302b may identify any conflicts with outputs from the planning module 304a including, but not limited to, instructions for controlling the operation of a vehicle. Planning monitor 302b may identify any conflicts with outputs from planning module 304a. According to some aspects of this disclosure, planning monitor 302b may execute independent analysis on data/information indicative of the environment around a vehicle and attempt to reconcile any identifications and/or calculations with output from the planning module 304a.

According to some aspects of this disclosure, processor 304 may include a perception monitor 304b that monitors the output (e.g., forecasts for objects, object identifications, etc.) from the perception module 302a. Perception monitor 304b may identify any conflicts with outputs from the planning module 304a including, but not limited to, forecasts for objects detected in proximity to a vehicle. Perception monitor 304b may identify any conflicts with outputs from perception module 302a. According to some aspects of this disclosure, perception monitor 304b may execute independent analysis on data/information indicative of the environment around a vehicle and attempt to reconcile any forecast and/or identifications with output from the perception module 302a.

According to some aspects of this disclosure, on-board computing system 320 may include a diagnostic module/system (e.g., configured on a PCB board and/or the like along with its processors, etc.) configured for domain-agnostic fault management. According to some aspects of this disclosure, a diagnostic module/system may analyze and/or validate the output from domain-specific (e.g., perception system monitor, planning system monitors, operation and control monitors, system integrity monitors, etc.) monitors of on-board computing system 320 to identify any hardware and/or operating system (OS) issues. For example, the diagnostic module/system may implement checksum validation, redundant execution analysis, and/or the like. According to some aspects of this disclosure, a diagnostic module may be configured with independent and compute-simple software that is isolated and/or protected from any hardware and OS faults/issues that may potentially affect other devices/components of on-board computing system 320.

According to some aspects of this disclosure, processor 302 may include a diagnostic module 302c. According to some aspects of this disclosure, diagnostic module 302c may be implemented for error reporting, plausibility checks, data sequence monitoring, communication timing supervision, and/or to trigger adequate fault responses for any identified issues with output from planning monitor 302b and/or perception monitor 304b. In an example scenario, diagnostic module 302c evaluates output from planning monitor 302b and perception monitor 304b and sends an instruction for causing a maneuver for a vehicle to vehicle control system 322 based on the evaluation. For example, diagnostic module 302c may receive an indication from perception monitor 304b of an identified conflict with a forecast for an object in proximity to a vehicle, or may receive an indication from planning monitor 302b of an identified conflict with instruction for controlling the operation of the vehicle. Based on either indicated conflict, diagnostic module 302c may assume a failure and/or issue with devices/components of on-board computing system 320 has occurred and thus trigger an appropriate fault/issue response for the vehicle. For example, diagnostic module 302c may send instruction and/or signal to vehicle control system 322 to cause an appropriate fault/issue response for the vehicle.

According to some aspects of this disclosure, any assumed failure and/or issue with devices/components of on-board computing system 320 may be mapped to and/or associated with a level of criticality that governs responsive actions taken by vehicle control system 322. For example, according to some aspects of this disclosure, any fault/issue with on-board computing system 320 and/or devices/components of system architecture 300A may initiate one or more specific Minimal Risk Condition (MRC) and/or vehicle control objectives that may be completed successfully.

According to some aspects of this disclosure, on-board computing system 320 may include a monitor for its diagnostic module/system. For example, a diagnostic monitor 306 may be configured to monitor the operational state of diagnostic module 302c. According to some aspects of this disclosure, diagnostic module 302c and diagnostic monitor 306 may continuously share a heartbeat signal. The heartbeat signal may be a periodic signal generated by hardware or software of diagnostic module 302c to indicate normal operation of diagnostic module 302c or to synchronize other devices/components of on-board computing system 320. Diagnostic monitor 306 may monitor the heartbeat signal to provide high availability and fault tolerance of operations of on-board computing system 320. A heartbeat signal is sent between diagnostic module 302c and diagnostic monitor 306 at regular intervals. However, if diagnostic monitor 306 does not receive a heartbeat for a time, for example, one or more heartbeat intervals, a fault/issue with diagnostic module 302c may be assumed. For example, diagnostic monitor 306 may assume an error with diagnostic module 302c has occurred and send an instruction to vehicle control system 322 to cause a maneuver for a vehicle, ignore a previous instruction for a device/component of on-board computing system 320 for causing a maneuver for the vehicle, and/or the like.

FIG. 3B shows an example system architecture 300B. According to some aspects of this disclosure, system architecture 300B may be similar to system architecture 300A. For example, perception module 302a and planning module 304a may still execute domain-specific functions, with perception monitor 304b and planning monitor 302b respectively monitoring those domain-specific functions. However, system architecture 300B is distinguishable from system architecture 300A such that in system architecture 300B, processor 304 of on-board computing system 320 includes a diagnostic module 304c with a similar configuration and operation as described for diagnostic module 302c. For example, diagnostic module 304c may be implemented for error reporting, plausibility checks, data sequence monitoring, communication timing supervision, and/or to trigger adequate fault responses for any identified issues with output from planning monitor 302b and/or perception monitor 304b. However, as shown in FIG. 3B, diagnostic module 302c and diagnostic module 304c independently generate their states from outputs from the planning monitor 302b and perception monitor 304b, allowing a disagreement between any evaluated states and/or conditions to trigger a response via vehicle control system 322 based on a belief of at least one unhealthy diagnostics module. According to some aspects of this disclosure, vehicle control system 322 may trigger an adequate fault/issue response regardless of which diagnostic module/system experiences a fault/issue.

FIG. 3C shows an example system architecture 300C. According to some aspects of this disclosure, system architecture 300C may be similar to system architecture 300B. For example, perception module 302a and planning module 304a may still execute domain-specific functions, with perception monitor 304b and planning monitor 302b respectively monitoring those domain-specific functions. Further, diagnostic module 302c and diagnostic module 304c independently generate their states from outputs from the planning monitor 302b and perception monitor 304b, allowing a disagreement between any evaluated states and/or conditions to trigger a response via vehicle control system 322 based on a belief of at least one unhealthy diagnostics module. According to some aspects of this disclosure, vehicle control system 322 may trigger an adequate fault/issue response regardless of which diagnostic module/system experiences a fault/issue. However, system architecture 300C is distinguishable from system architecture 300B such that on-board computing system 320 may include a monitor for diagnostic module 302c and diagnostic module 304c. For example, a diagnostic monitor 308 may be configured to monitor the operational states of diagnostic module 302c and diagnostic module 304c. Diagnostic monitor 308 may be implemented for hardening (e.g., reduce vulnerability, etc.) of on-board computing system 320.

According to some aspects of this disclosure, diagnostic module 302c, diagnostic module 304c, and diagnostic monitor 308 may continuously share heartbeat signals. The heartbeat signals may be a periodic signal generated by hardware or software of diagnostic module 302c and diagnostic module 304c to indicate normal operation of diagnostic module 302c and diagnostic module 304c or to synchronize other devices/components of on-board computing system 320. Diagnostic monitor 308 may monitor the heartbeat signals to provide high availability and fault tolerance of operations of on-board computing system 320. Heartbeat signals may be sent between diagnostic module 302c and diagnostic monitor 308 at regular intervals and diagnostic module 304c and diagnostic monitor 308 at regular intervals. However, if diagnostic monitor 308 does not receive a heartbeat for a time, for example, one or more heartbeat intervals, a fault/issue with either diagnostic module 302c or diagnostic module 304c may be assumed. For example, diagnostic monitor 308 may assume an error with diagnostic module 302c or diagnostic module 304c has occurred and send an instruction to vehicle control system 322 to cause a maneuver for a vehicle, ignore a previous instruction for a device/component of on-board computing system 320 for causing a maneuver for the vehicle, and/or the like.

FIG. 3D shows an example system architecture 300D. According to some aspects of this disclosure, system architecture 300D may be similar to system architecture 300C. For example, perception module 302a and planning module 304a may still execute domain-specific functions, with perception monitor 304b and planning monitor 302b respectively monitoring those domain-specific functions. Again, diagnostic module 302c and diagnostic module 304c independently generate their states from outputs from the planning monitor 302b and perception monitor 304b, allowing a disagreement between any evaluated states and/or conditions to trigger a response via vehicle control system 322 based on a belief of at least one unhealthy diagnostics module. Further, diagnostic monitor 308 is configured to monitor the operational states of diagnostic module 302c and diagnostic module 304c, and provide hardening (e.g., reduce vulnerability, etc.) of on-board computing system 320. Vehicle control system 322 may trigger an adequate fault/issue response regardless of which diagnostic module/system experiences a fault/issue. However, system architecture 300D is distinguishable from system architecture 300C such that diagnostic module 302c and diagnostic module 304c do not communicate and/or reconcile their analysis. Instead, diagnostic monitor 308 monitors heartbeats from diagnostic module 302c and diagnostic module 304c, and if one goes latent, diagnostic monitor 308 sends an instruction to vehicle control system 322 for appropriate vehicle response. If both diagnostic module 302c and diagnostic module 304c have heartbeats but there is a disagreement in their outputs, diagnostic monitor 308 may take the most drastic action identified for a response to outputs of diagnostic module 302c and diagnostic module 304c.

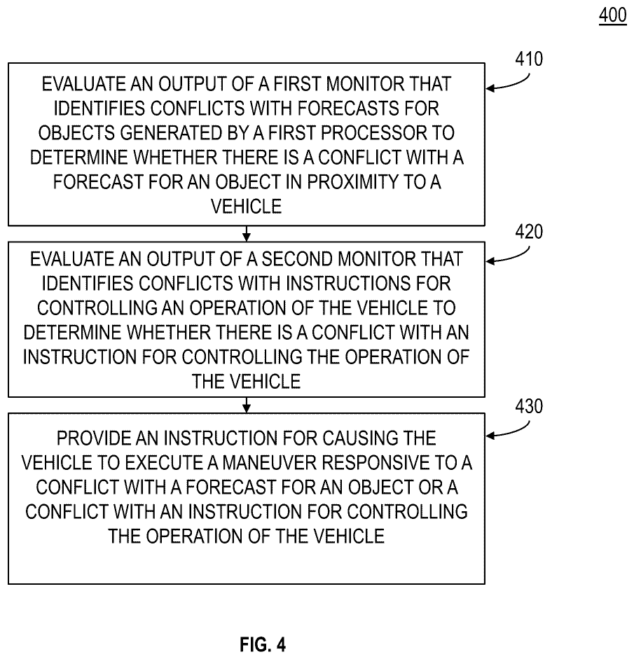

FIG. 4 shows a flowchart of an example method 400 for mutual monitoring of high-performance computing systems to control vehicle operation, according to some aspects of this disclosure. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIGS. 1-3D. However, method 400 is not limited to the aspects of those figures. The on-board computing system 320 (e.g., on-board computing system 113, on-board computing system 220, etc.) may facilitate mutual monitoring of high-performance computing systems to control vehicle operation.

In 410, on-board computing system 320 (e.g., diagnostic module 302c, etc.) of a vehicle evaluates an output of a first monitor (e.g., perception monitor 304b, etc.) configured to identify conflicts with forecasts for objects in proximity to the vehicle generated by a first processor (e.g., perception module 302a, etc.) based on perception information that indicates the objects to determine whether there is a conflict with a forecast for an object of the objects in proximity to the vehicle.

In 420, on-board computing system 320 (e.g., diagnostic module 302c, etc.) evaluates an output of a second monitor (e.g., planning monitor 302b, etc.) configured to identify conflicts with instructions for controlling operations of the vehicle generated by a second processor (e.g., planning module 304a, etc.) based on the perception information to determine whether there is a conflict with an instruction of the instructions for controlling operations of the vehicle.

In 430, on-board computing system 320 (e.g., diagnostic module 302c, etc.) provides an instruction for causing the vehicle to execute a maneuver responsive to at least one of the conflict with the forecast or the conflict with the instruction.

According to some aspects of this disclosure, to provide the instruction for causing the vehicle to execute the maneuver, on-board computing system 320 (e.g., diagnostic module 302c, etc.) identifies a first level of criticality for the conflict with the forecast for the object, a second level of criticality for the conflict with the instruction for controlling the operation of the vehicle, and/or the like. According to some aspects of this disclosure, on-board computing system 320 (e.g., diagnostic module 302c, etc.) sends the instruction for causing the vehicle to execute the maneuver to at least one vehicle controller (e.g., vehicle control system 322, etc.) for the vehicle based on the first level of criticality, the second level of criticality, and/or the like. According to some aspects of this disclosure, the at least one vehicle controller (e.g., vehicle control system 322, etc.) for the vehicle may be mapped to the first level of criticality, the second level of criticality, and/or the like.

According to some aspects of this disclosure, the on-board computing system 320 (e.g., diagnostic module 302c, etc.) providing the instruction for causing the vehicle to execute the maneuver may include on-board computing system 320 (e.g., diagnostic module 302c, etc.) providing the instruction to a third monitor (e.g., diagnostic monitor 306, etc.) that monitors instructions for executing maneuvers. According to some aspects of this disclosure, based on an amount of time since at least one of the instruction for causing the vehicle to execute the maneuver or a different instruction for causing the vehicle to execute a different maneuver is received exceeding a threshold, the third monitor is configured to cause a selected maneuver for the vehicle. For example, the third monitor may select a maneuver for the vehicle and send an instruction to at least one vehicle controller (e.g., vehicle control system 322, etc.) for the vehicle to execute the selected maneuver.

According to some aspects of this disclosure, the method 400 may include on-board computing system 320 (e.g., diagnostic module 302c, etc.) providing an instruction to at least one vehicle controller (e.g., vehicle control system 322, etc.) for the vehicle to ignore the instruction for causing the maneuver for the vehicle based on a determination that at least one of: the determined conflict with the instruction for controlling the operation of the vehicle is invalid or the determined conflict with the forecast for the object is invalid.

According to some aspects of this disclosure, the method 400 may include on-board computing system 320 (e.g., diagnostic module 302c, etc.) providing to a third monitor (e.g., diagnostic monitor 306, etc.) configured to monitor an operational state of on-board computing system 320 (e.g., diagnostic module 302c, etc.), an indication of the operational state. According to some aspects of this disclosure, based on the operational state, the third monitor (e.g., diagnostic module 302c, etc.) provides an instruction to at least one vehicle controller (e.g., vehicle control system 322, etc.) for the vehicle to at least one of: ignore the instruction for causing the vehicle to execute the maneuver or cause the vehicle to execute a different maneuver.

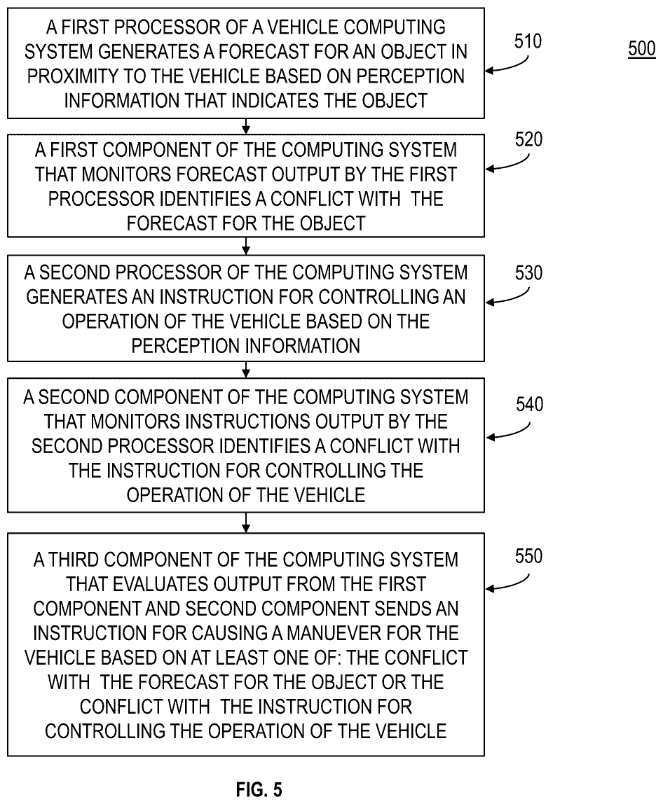

FIG. 5 shows a flowchart of an example method 500 for mutual monitoring of high-performance computing systems to control vehicle operation, according to some aspects of this disclosure. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIGS. 1-3D. However, method 500 is not limited to the aspects of those figures. The on-board computing system 320 (e.g., on-board computing system 113, on-board computing system 220, etc.) may facilitate mutual monitoring of high-performance computing systems to control vehicle operation.

In 510, a first processor (e.g., perception module 302a, etc.) of on-board computing system 320 generates a forecast for an object in proximity to a vehicle. According to some aspects of this disclosure, the first processor may generate the forecast for the object based on perception information that indicates the object. According to some aspects of this disclosure, the perception information may be received from one or more sensors associated with the vehicle.

In 520, a first component (e.g., perception monitor 304b, etc.) of on-board computing system 320 that monitors forecasts output by the first processor identifies a conflict with the forecast for the object. According to some aspects of this disclosure, the first component may identify the conflict with the forecast for the object based on the perception information.

In 530, a second processor (e.g., planning module 304a, etc.) of on-board computing system 320 generates an instruction for controlling an operation of the vehicle. According to some aspects of this disclosure, the instruction for controlling the operation of the vehicle may include, but is not limited to, a trajectory for the vehicle and/or the like. According to some aspects of this disclosure, the second processor may generate the instruction for controlling the operation of the vehicle based on the perception information.

In 540, a second component (e.g., planning monitor 302b, etc.) of on-board computing system 320 that monitors instructions output by the second processor, identifies a conflict with the instruction for controlling the operation of the vehicle. According to some aspects of this disclosure, the second component may identify the conflict with the instruction for controlling the operation of the vehicle based on the perception information.

In 550, a third component (e.g., diagnostic module 302c, etc.) of on-board computing system 320 that evaluates output from the first component and the second component sends an instruction for causing a maneuver for the vehicle. According to some aspects of this disclosure, the third component sends the instruction for causing the maneuver for the vehicle based on at least one of the identified conflict with the forecast for the object or the identified conflict with the instruction for controlling the operation of the vehicle.

According to some aspects of this disclosure, sending the instruction for causing the maneuver for the vehicle may include identifying at least one of a first level of criticality for the identified conflict with the forecast for the object or a second level of criticality for the identified conflict with the instruction for controlling the operation of the vehicle. According to some aspects of this disclosure, the third component of on-board computing system 320 may send the instruction for causing the maneuver for the vehicle to at least one vehicle controller for the vehicle based on at least one of the first level of criticality or the second level of criticality. According to some aspects of this disclosure, the at least one vehicle controller (e.g., vehicle control system 322, etc.) for the vehicle may be mapped to at least one of the first level of criticality or the second level of criticality.

According to some aspects of this disclosure, the method 500 may include a fourth component (e.g., diagnostic module 304c, etc.) of on-board computing system 320 that evaluates output from the first component and the second component sending an instruction to at least one vehicle controller (e.g., vehicle control system 322, etc.) for the vehicle to ignore the instruction for causing the maneuver for the vehicle. According to some aspects of this disclosure, the fourth component may send the instruction to ignore the instruction for causing the maneuver for the vehicle based on at least one of the identified conflict with the forecast for the object or the identified conflict with the instruction for controlling the operation of the vehicle.

According to some aspects of this disclosure, the method 500 may include a fourth component (e.g., diagnostic monitor 306, etc.) of on-board computing system 320 that monitors an operational state of the third component sending an instruction to at least one vehicle controller (e.g., vehicle control system 322, etc.) for the vehicle to at least one of: ignore the instruction for causing the maneuver for the vehicle or cause a different maneuver for the vehicle. According to some aspects of this disclosure, the fourth component that monitors the operational state of the third component may send the instruction to at least one vehicle controller (e.g., vehicle control system 322, etc.) for the vehicle to at least one of: ignore the instruction for causing the maneuver for the vehicle or cause a different maneuver for the vehicle based on the operation state indicating an error with the third component.

According to some aspects of this disclosure, the method 500 may include a fourth component (e.g., diagnostic module 304c, etc.) of on-board computing system 320 that monitors output from the first component and the second component sending a different instruction for causing the maneuver for the vehicle. According to some aspects of this disclosure the fourth component sends the different instruction for causing the maneuver for the vehicle based on at least one of the identified conflict with the forecast for the object or the identified conflict with the instruction for controlling the operation of the vehicle. According to some aspects of this disclosure, a fifth component (e.g., diagnostic monitor 308, etc.) of on-board computing system 320 that monitors instructions from the third component and the fourth component may cause a different maneuver for the vehicle. According to some aspects of this disclosure, the fifth component causes the different maneuver for the vehicle based on an amount of time since at least one of the instruction for causing the maneuver for the vehicle or the different instruction for causing the maneuver for the vehicle is received exceeding a threshold,

According to some aspects of this disclosure, the method 500 may include a fourth component (e.g., diagnostic module 304c, etc.) of on-board computing system 320 that monitors output from the first component and the second component generating an instruction for causing a different maneuver for the vehicle. According to some aspects of this disclosure, the fourth component generates the instruction for causing the different maneuver for the vehicle based on at least one of the identified conflict with the forecast for the object or the identified conflict with the instruction for controlling the operation of the vehicle. According to some aspects of this disclosure, a fifth component (e.g., diagnostic monitor 308, etc.) of on-board computing system 320 that monitors instructions from the third component and the fourth component may cause at least one of the maneuver for the vehicle or the different maneuver for the vehicle. According to some aspects of this disclosure, the fifth component causes at least one of the maneuver for the vehicle or the different maneuver for the vehicle based on a comparison of a level of criticality for the maneuver for the vehicle and level of criticality for the different maneuver for the vehicle.

Various examples, aspects, and/or embodiments described herein can be implemented, for example, using one or more computer systems, such as computer system 600 shown in FIG. 6. Computer system 600 can be any computer capable of performing the functions described herein.

Computer system 600 can be any well-known computer capable of performing the functions described herein. According to some aspects of this disclosure, the on-board computing system 113 of FIG. 1, the on-board computing system 220 of FIG. 2, the on-board computing system 320 of FIGS. 3A-3D, and/or any other device/component described herein may be implemented using the computer system 600. According to some aspects of this disclosure, the computer system 600 may be used and/or specifically configured to implement methods 400 and 500.

Computer system 600 includes one or more processors (also called central processing units, or CPUs), such as a processor 604. Processor 604 is connected to a communication infrastructure (and/or bus) 606.

One or more processors 604 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 also includes user input/output device(s) 603, such as monitors, keyboards, pointing devices, etc., that communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, a tape backup device, and/or any other storage device/drive.

Removable storage drive 614 may interact with a removable storage unit 618. Removable storage unit 618 includes a computer-usable or readable storage device having stored thereon computer software (control logic) and/or data. Removable storage unit 618 may be a floppy disk, magnetic tape, compact disk, DVD, optical storage disk, and/or any other computer data storage device. Removable storage drive 614 reads from and/or writes to removable storage unit 618 in a well-known manner.

According to an exemplary embodiment, secondary memory 610 may include other means, instrumentalities, or other approaches for allowing computer programs and/or other instructions and/or data to be accessed by computer system 600. Such means, instrumentalities, or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described examples, aspects, and/or exemplary embodiments, but should be defined only in accordance with the following claims and their equivalents.

What is claimed is:

1. A method, comprising:
evaluating, by one or more computing devices of a vehicle, an output of a first monitor configured to identify conflicts with forecasts for objects in proximity to the vehicle generated by a first processor based on perception information that indicates the objects to determine whether there is a conflict with a forecast for an object of the objects in the proximity;
evaluating, by the one or more computing devices of the vehicle, an output of a second monitor configured to identify conflicts with instructions for controlling operations of the vehicle generated by a second processor based on the perception information to determine whether there is a conflict with an instruction of the instructions for controlling the operations of the vehicle; and
providing, by the one or more computing devices of the vehicle, an instruction for causing the vehicle to execute a maneuver responsive to at least one of the conflict with the forecast or the conflict with the instruction.

2. The method of claim 1, wherein the perception information is generated by one or more sensors associated with the vehicle.

3. The method of claim 1, wherein the providing the instruction for causing the vehicle to execute the maneuver comprises:
identifying, by the one or more computing devices of the vehicle, at least one of a first level of criticality for the conflict with the forecast for the object or a second level of criticality for the conflict with the instruction for controlling the operation of the vehicle; and
providing, by the one or more computing devices of the vehicle, based on at least one of the first level of criticality or the second level of criticality, the instruction for causing the vehicle to execute the maneuver to at least one vehicle controller for the vehicle.

4. The method of claim 3, wherein the at least one vehicle controller for the vehicle is mapped to at least one of the first level of criticality or the second level of criticality.

5. The method of claim 1, further comprising providing, by the one or more computing devices of the vehicle, an instruction to at least one vehicle controller for the vehicle to ignore the instruction for causing the maneuver for the vehicle based on a determination that at least one of: the determined conflict with the instruction for controlling the operation of the vehicle is invalid or the determined conflict with the forecast for the object is invalid.

6. The method of claim 1 further comprising providing, by the one or more computing devices of the vehicle, to a third monitor configured to monitor an operational state of the one or more computing devices, an indication of the operational state, wherein based on the operational state the third monitor provides an instruction to at least one vehicle controller for the vehicle to at least one of: ignore the instruction for causing the vehicle to execute the maneuver or cause the vehicle to execute a different maneuver.

7. The method of claim 1, wherein the providing the instruction for causing the vehicle to execute the maneuver comprises providing the instruction to a third monitor that monitors instructions for executing maneuvers, wherein based on an amount of time since at least one of the instruction for causing the vehicle to execute the maneuver or a different instruction for causing the vehicle to execute a different maneuver is received exceeding a threshold, the third monitor is configured to cause a selected maneuver for the vehicle.

8. A computing system for a vehicle, comprising:
a memory; and
at least one processor coupled to the memory and configured to perform operations comprising:
evaluating an output of a first monitor configured to identify conflicts with forecasts for objects in proximity to the vehicle generated by a first processor based on perception information that indicates the objects to determine whether there is a conflict with a forecast for an object of the objects in the proximity;
evaluating an output of a second monitor configured to identify conflicts with instructions for controlling operations of the vehicle generated by a second processor based on the perception information to determine whether there is a conflict with an instruction of the instructions for controlling the operations of the vehicle; and
providing an instruction for causing the vehicle to execute a maneuver responsive to at least one of the conflict with the forecast or the conflict with the instruction.

9. The system of claim 8, wherein the perception information is generated by one or more sensors associated with the vehicle.

10. The system of claim 8, wherein the providing the instruction for causing the vehicle to execute the maneuver comprises:
Identifying at least one of a first level of criticality for the conflict with the forecast for the object or a second level of criticality for the conflict with the instruction for controlling the operation of the vehicle; and
providing, based on at least one of the first level of criticality or the second level of criticality, the instruction for causing the vehicle to execute the maneuver to at least one vehicle controller for the vehicle.

11. The system of claim 10, wherein the at least one vehicle controller for the vehicle is mapped to at least one of the first level of criticality or the second level of criticality.

12. The system of claim 8, the operations further comprising providing an instruction to at least one vehicle controller for the vehicle to ignore the instruction for causing the maneuver for the vehicle based on a determination that at least one of: the determined conflict with the instruction for controlling the operation of the vehicle is invalid or the determined conflict with the forecast for the object is invalid.

13. The system of claim 8, further comprising providing to a third monitor configured to monitor an operational state of the system, an indication of the operational state, wherein based on the operational state the third monitor provides an instruction to at least one vehicle controller for the vehicle to at least one of: ignore the instruction for causing the vehicle to execute the maneuver or cause the vehicle to execute a different maneuver.

14. The system of claim 8, wherein the providing the instruction for causing the vehicle to execute the maneuver comprises providing the instruction to a third monitor that monitors instructions for executing maneuvers, wherein based on an amount of time since at least one of the instruction for causing the vehicle to execute the maneuver or a different instruction for causing the vehicle to execute a different maneuver is received exceeding a threshold, the third monitor is configured to cause a selected maneuver for the vehicle.

15. A non-transitory computer-readable medium having instructions stored thereon that, when executed by a computing system for a vehicle, cause the computing system to perform operations comprising:
evaluating an output of a first monitor configured to identify conflicts with forecasts for objects in proximity to the vehicle generated by a first processor based on perception information that indicates the objects to determine whether there is a conflict with a forecast for an object of the objects in the proximity;
evaluating an output of a second monitor configured to identify conflicts with instructions for controlling operations of the vehicle generated by a second processor based on the perception information to determine whether there is a conflict with an instruction of the instructions for controlling the operations of the vehicle; and
providing an instruction for causing the vehicle to execute a maneuver responsive to at least one of the conflict with the forecast or the conflict with the instruction.

16. The non-transitory computer-readable medium of claim 15, wherein the perception information is generated by one or more sensors associated with the vehicle.

17. The non-transitory computer-readable medium of claim 15, wherein the providing the instruction for causing the vehicle to execute the maneuver comprises:
Identifying at least one of a first level of criticality for the conflict with the forecast for the object or a second level of criticality for the conflict with the instruction for controlling the operation of the vehicle; and
providing, based on at least one of the first level of criticality or the second level of criticality, the instruction for causing the vehicle to execute the maneuver to at least one vehicle controller for the vehicle.

18. The non-transitory computer-readable medium of claim 17, wherein the at least one vehicle controller for the vehicle is mapped to at least one of the first level of criticality or the second level of criticality.

19. The non-transitory computer-readable medium of claim 15, the operations further comprising providing an instruction to at least one vehicle controller for the vehicle to ignore the instruction for causing the maneuver for the vehicle based on a determination that at least one of: the determined conflict with the instruction for controlling the operation of the vehicle is invalid or the determined conflict with the forecast for the object is invalid.

20. The non-transitory computer-readable medium of claim 15, further comprising providing to a third monitor configured to monitor an operational state of the computing system, an indication of the operational state, wherein based on the operational state the third monitor provides an instruction to at least one vehicle controller for the vehicle to at least one of: ignore the instruction for causing the vehicle to execute the maneuver or cause the vehicle to execute a different maneuver.
